(19) United States
(12) Patent Application Publication
(10) Pub. No.: US 2025/0037096 A1
(43) Pub. Date: Jan. 30, 2025

(54) DECENTRALIZED AND ATOMIC SETTLEMENT OF INTER-BANK TRANSFERS USING SMART CONTRACT

(71) Applicant: Partior Pte. Ltd., Singapore (SG)

(72) Inventors: Krishnan Narayanan, Singapore (SG); Rodion Lim, Singapore (SG); Saxon Bartrop, Singapore (SG); Frank Lim, Singapore (SG); Sont Rahardja, Singapore (SG); Atul Bhuchar, Singapore (SG); Thiyagarajan Maruthaiah, Singapore (SG)

(21) Appl. No.: 18/782,881

(22) Filed: Jul. 24, 2024

Related U.S. Application Data
(60) Provisional application No. 63/515,427, filed on Jul. 25, 2023.
(60) Provisional application No. 63/517,857, filed on Aug. 4, 2023.
(60) Provisional application No. 63/583,425, filed on Sep. 18, 2023.
(60) Provisional application No. 63/583,429, filed on Sep. 18, 2023.
(60) Provisional application No. 63/607,669, filed on Dec. 8, 2023.

(51) Int. Cl. G06Q 20/10; G06Q 40/04

(52) U.S. Cl. CPC G06Q 20/10; G06Q 40/04; G06Q 2220/00

(57) ABSTRACT

Methods and systems are presented for providing a blockchain framework that enables different computer nodes of a blockchain network to collaborate in the processing a atomic transactions to be recorded on a blockchain. The atomic transaction can be associated with various inter-entity transactions where funds is transferred from an account of an entity to another account of another entity. The blockchain framework uses various smart contracts to process the postings associated with an inter-entity transaction such that different postings are processed by different nodes, and that the postings are processed together as a single atomic transaction to be recorded on the blockchain.

### CROSS-REFERENCE TO RELATED APPLICATIONS

The present application claims priority to U.S. Provisional Patent Application Ser. No. 63/515,427, filed Jul. 25, 2023, U.S. Provisional Patent Application Ser. No. 63/517,857, filed Aug. 4, 2023, U.S. Provisional Patent Application Ser. No. 63/583,425, filed Sep. 18, 2023, U.S. Provisional Patent Application Ser. No. 63/583,429, filed Sep. 18, 2023, and U.S. Provisional Patent Application Ser. No. 63/607,669, filed Dec. 8, 2023, which are incorporated by reference herein in their entirety.

### TECHNICAL FIELD

The present specification generally relates to providing a framework for performing atomic settlement of inter-bank transfers using smart contracts on blockchains.

### BACKGROUND

In a blockchain-based inter-bank payment network, the settlement of a credit transfer refers to the process of posting a debit transaction to the debtor agent's account conditional to the posting of a credit transaction to the creditor agent's account. These two postings can happen within the same ledger (e.g., recorded on the same blockchain) or between two different ledgers (e.g., recorded on different blockchains). Conventionally, the debit transaction and the credit postings are processed sequentially, where one posting (e.g., the debit posting) is processed and completed before the other posting (e.g., the credit posting) is processed. However, since the two postings are part of a single transfer of funds between two banks, the two postings should be conditional upon each other (e.g., the postings should both succeed or fail together). Treating the two postings as separate transactions would create of risk of irreconcilable accounting when one of the transactions succeed and the other one fail.

Existing blockchain technologies lack the infrastructure to provide a secured framework to perform different postings in a single and atomic transaction. As such, there is a need for providing a blockchain-based framework that would ensure an atomic settlement of inter-bank transfers.

### BRIEF DESCRIPTION OF THE FIGURES

FIG. 1 is a block diagram illustrating a networked system in which a blockchain framework according to an embodiment of the present disclosure can be implemented;

FIG. 2 is a schematic view illustrating an electronic token according to an embodiment of the present disclosure;

FIG. 3 is a schematic view illustrating a token transaction ledger according to an embodiment of the present disclosure;

FIG. 4 illustrates an operation sequence for processing a blockchain-based inter-entity funds transfer transaction according to an embodiment of the present disclosure;

FIG. 5 is a block diagram illustrating different transaction modules according to an embodiment of the present disclosure;

FIG. 6 illustrates effects of a funds reservation transaction on a blockchain at various points in time according to an embodiment of the present disclosure;

FIG. 7 illustrates another operation sequence for processing a blockchain-based inter-entity funds transfer transaction according to an embodiment of the present disclosure;

FIG. 8 illustrates an operation sequence associated with processing a blockchain-based inter-entity currency exchange transaction according to an embodiment of the present disclosure;

FIG. 9 illustrates an example process for performing a blockchain-based inter-entity funds transfer transaction according to an embodiment of the present disclosure;

FIG. 10 illustrates another example process for performing a blockchain-based inter-entity funds transfer transaction according to an embodiment of the present disclosure;

FIG. 11 illustrates an example process for performing a blockchain-based inter-entity currency exchange transaction according to an embodiment of the present disclosure; and

FIG. 12 is a block diagram of a system for implementing a device according to an embodiment of the present disclosure.

### DETAILED DESCRIPTION

The present disclosure includes methods and systems for providing a blockchain framework that enables different computer nodes associated with different entities to collaborate in the processing of atomic transactions to be recorded on a blockchain. The atomic transaction may be associated with an inter-entity (e.g., inter-bank) transaction where funds are transferred from one entity to another entity (or exchanged between different entities). In some embodiments, the blockchain framework uses various smart contracts to process different postings associated with an inter-entity transaction (e.g., a fund transfer transaction across different banks, a foreign exchange transaction across different entities, etc.), such that the different postings are processed as a single atomic transaction and recorded on the blockchain. An inter-entity funds transfer transaction typically involves transferring funds from one entity (e.g., a first entity) to another entity (e.g., a second entity). Traditionally, one or more settlement entities (e.g., settlement banks) may facilitate such a transfer. For example, when two entities involved in a fund transfer transaction have nostro relationships with the same settlement entity (each of the two entities has an account with the settlement entity), the settlement entity may facilitate the transfer of funds between the two accounts corresponding to the two entities. The settlement entity may keep a ledger that records all of the transactions that involve the accounts with the settlement entity. The settlement entity may then process a series of postings that transfer the funds from a first account of a first entity to a second account to a second entity and update the ledger accordingly. In some embodiments, the blockchain framework of some embodiments provides a blockchain infrastructure that enables the settlement entity to record and manage the records on a blockchain. Furthermore, the blockchain framework allows multiple settlement entities to record transactions associated with the respective ledgers on the same blockchain. Using a single blockchain to manage transactions across different ledgers enable entities of a transaction to execute a single atomic transaction for recordation on the blockchain even though the transaction requires changes to be made in multiple ledgers.

As discussed herein, an inter-entity transaction typically involves multiple steps. Consider a simple scenario where the transferring of funds involves two participating entities (e.g., transferring of funds from a first participating entity to a second participating entity), and both of the participating entities have nostro relationships with the same settlement entity (e.g., both entities have respective accounts with the settlement entity). The fund transfer transaction may involve initially transferring funds from a first account of a first entity to an intermediate account of the settlement entity (e.g., a settlement bank), and then transferring the funds from the intermediate account of the settlement entity to a second account of the second entity. As such, a fund transfer transaction may include processing multiple postings, where each posting represents a change of an account balance of a respective account in the ledger, including a first posting associated with processing a debit of funds from the first account of the first participating entity, a second posting associated with processing a credit of the funds to the intermediate account of the settlement entity, a third posting associated with processing a debit of the funds from the intermediate account, and a fourth posting associated with processing a credit of the funds to the second account of the second participating entity.

The number of postings may be even larger when the transfer of funds is conducted in a more complex scenario where the two participating entities have nostro relationships with different settlement entities (e.g., a first participating entity has a nostro relationship with a first settlement entity, and a second participating entity has a nostro relationship with a second settlement entity, etc.), such that updates are made to multiple ledgers. In such a complex scenario, the fund transfer transaction may include a first posting associated with processing a debit of funds from a first participating entity account of the first participating entity (first ledger), a second posting associated with processing a credit of the funds to a first intermediate account of a first settlement entity (first ledger), a third posting associated with processing a debit of the funds from the first intermediate account (first ledger/second ledger), a fourth posting associated with processing a credit of the funds to a second intermediate account of a second settlement entity (first ledger/second ledger), a fifth posting associated with processing a debit of the funds from the second intermediate account (second ledger), and a sixth posting associated with processing a credit of the funds to the second participating entity account of the second participating entity (second ledger).

In order to process the fund transfer transaction, all of the postings must be processed together. Given that blockchain transactions are immutable after being recorded, if only a subset of the postings is processed on the blockchain, the first entity risks losing the funds without having the transaction completed (e.g., when the funds have been transferred from the account of the first entity but have not been received by the account of the second entity). As such, the blockchain framework of some embodiments provides a mechanism for different computer nodes associated with different entities to collaborate in the processing of the different postings associated with the fund transfer as a single atomic transaction to be recorded on the blockchain.

In some embodiments, a server associated with the blockchain framework provides (or creates) a blockchain for recording transactions related to accounts of different entities. As discussed herein, different entities may have nostro relationships with different settlement entities. For example, a first set of entities may have nostro relationships with a first settlement entities and a second set of entities may have nostro relationships with a second settlement entities. An entity that has a nostro relationship with a settlement entity may be referred to as a participating entity (e.g., a “participating bank,” etc.) for the settlement entity. An entity can be a participating entity for multiple settlement entities, such that the first set of entities and the second set of entities may be non-overlapping or at least partially overlapping. Furthermore, a settlement entity may also have a nostro relationship with another settlement entity (e.g., becoming a participating entity with the other settlement entity). Each settlement entity may manage accounts of entities that have nostro relationships with that settlement entity. As such, the blockchain framework enables each settlement entity to create a corresponding ledger on the blockchain. Since multiple settlement entities may create different ledgers on the blockchain, the blockchain framework may provide a mechanism to distinguish records (e.g., transactions) that are stored on the blockchain and associated with the different ledgers (e.g., transactions that are facilitated by different settlement entities, etc.). For example, each ledger may be identified on the blockchain based on a smart contract (or smart contract identifier) associated with the ledger.

In some embodiments, the server associated with the blockchain framework provides executable programs (also referred to as “client modules” or “transaction modules”) that are installed and/or executed on the computer nodes associated with the different entities. The computer nodes may be part of a blockchain network and configured to process transactions associated with the corresponding ledgers on the blockchain (e.g., performing validation, performing proof-of-work/proof-of-stake consensus mechanisms, recording transaction records on the blockchain, etc.). In some embodiments, the executable programs are configured to perform one or more functions on behalf of the corresponding computer nodes and the corresponding entities. For example, the executable program of a computer node associated with a settlement entity may be configured to generate and/or store smart contracts related to the ledger managed by the settlement entity on the blockchain. The smart contracts may then be used (e.g., executed) by other computer nodes associated with the participating entities of the settlement entity to process transactions (e.g., inter-entity funds transfers, inter-entity foreign exchanges (currency exchanges), etc.). For example, when a request to process a funds transfer transaction is received, the executable programs may execute one or more smart contracts to process the funds transfer transaction. As discussed herein, a funds transfer transaction may involve multiple postings related to the different accounts involved in the funds transfer transaction. The executable programs of the computer nodes may collaborate to process all of the postings related to the funds transfer transaction in a single atomic transaction and record the atomic transaction on the blockchain.

In some embodiments, the executable programs of the different computer nodes perform different functions for the atomic transaction. Specifically, each executable program may be configured to perform different functions for the atomic transaction based on an identity of the entity associated with the computer node (e.g., a role of the entity in the fund transfer transaction, etc.). Consider the example of a funds transfer discussed above, where funds are transferred from a first participating entity to a second participating entity via a settlement entity. Since the settlement entity has records of all of the accounts of its participating entity, the executable program of a computer node associated with the settlement entity may process all of the postings associated with the funds transfer, such as a first posting associated with processing a debit of funds from a first account of the first participating entity, a second posting associated with processing a credit of the funds to an intermediate account of the settlement entity, a third posting associated with processing a debit of the funds from the intermediate account, and a fourth posting associated with processing a credit of the funds to a second account of the second participating entity.

However, each of the participating entities may only have knowledge of the records associated with its own account and may not (and should not) have knowledge about the counter party account and the settlement bank account. As such, to process the funds transfer, the executable program of the computer node associated with the first participating entity only processes the postings related to the first account of the first participating entity and does not process the postings related to the intermediary account or the second account of the second participating entity. Similarly, the executable program of the computer node associated with the second participating entity may only process the postings related to the second account of the second participating entity and may not process the postings related to the intermediary account or the first account of the first participating entity.

The executable programs of the computer nodes of the first participating entity, the second participating entity, and the settlement entity may collaborate (e.g., through a consensus mechanism associated with the blockchain, etc.) to perform the process to record the postings as a single atomic transaction on the blockchain. In some embodiments, the transaction that is recorded on the blockchain indicates information associated with the funds transfer between the first participating entity and the second participating entity, but does not include specific information associated with the various accounts (e.g., the first account of the first participating entity, the intermediary account of the settlement entity, and the second account of the second participating entity).

In some embodiments, in addition to managing the blockchain, each executable program generates two different data storages (e.g., a public data storage and a private data storage, etc.) on the corresponding computer node for storing additional information associated with inter-entity transactions related to the corresponding account. For example, the executable program of the computer node associated with the settlement entity may be configured to store information associated with all of the postings related to each inter-entity funds transfer facilitated by the settlement entity. In some embodiments, the executable program of the settlement entity stores additional public information associated with the transaction in the public data storage, such as a description of the transaction, any other related transactions, etc. The executable program may also store private information, such as the debit and/or the credit postings associated with the participating bank accounts, the debit and the credit postings associated with the intermediary accounts, and the balances of the different participating bank accounts, in the private data storage. The executable program may also associate/link the information stored in the public data storage and the private data storage with the transaction record of the atomic transaction recorded on the blockchain, such that the information (e.g., postings or other records that represent changes to the accounts) stored in the data storages can be matched with transactions recorded on the blockchain.

The executable program of the computer node associated with the first participating entity may also store information related to the transaction in its corresponding public data storage and private data storage. For example, since the executable program of the first participating entity only processes the posting related to the debit of the funds from the first account of the first participating entity, the executable program may store the debit posting and the updated balance of the first account in the private data storage and may store any public information related to the transaction in the public data storage. The executable program may also associate the information/postings stored in the data storages with the corresponding record/transaction recorded on the blockchain.

Similarly, the executable program of the computer node associated with the second participating entity may also store information related to the transaction in its corresponding public data storage and private data storage. For example, since the executable program of the second participating entity only processes the posting related to the credit of the funds to the second account of the second participating entity, the executable program may store the credit posting and an updated account balance of the second account in the private data storage and may store any public information related to the transaction in the public data storage. The executable program may also associate the information/postings stored in the data storages with the corresponding record/transaction recorded on the blockchain.

By utilizing the executable programs that perform different functions for an inter-entity transaction through smart contracts based on the corresponding roles within the inter-entity transaction, and linking transactions recorded on the blockchain with various records stored in public and/or private data storages, the blockchain framework enables inter-entity transactions to be processed in a secured manner. Furthermore, by separating private data that can be stored in local computer nodes from the transaction records stored on the blockchain, the blockchain framework provides enhanced privacy to the entities that participate in the blockchain network. For example, each entity can verify the transactions based on the records stored on the blockchain. However, the entity may only be able to access limited information associated with the transactions (e.g., the existence of the transactions, the identities of the parties involved in the transactions, etc.) and does not have access to sensitive information, such as account balances of accounts belonging to other participating entities and/or settlement entities, etc. Specifically, since the blockchain can be accessed by at least the entities associated with the blockchain network, any entity that is part of the blockchain network can look up transactions conducted among the entities on the blockchain. However, the information that the entity may access may be different based on the participation (e.g., the role) of the entity in each of the transactions. When the entity is involved in a transaction, the executable program of the entity can retrieve information of the transaction from the blockchain, and also retrieve additional private and/or public information associated with the transaction from its local public data storage and the local private data storage. On the other hand, if the entity is not involved in the transaction, the executable program may only be able to retrieve the limitation recorded on the blockchain, and not the other additional public/private information.

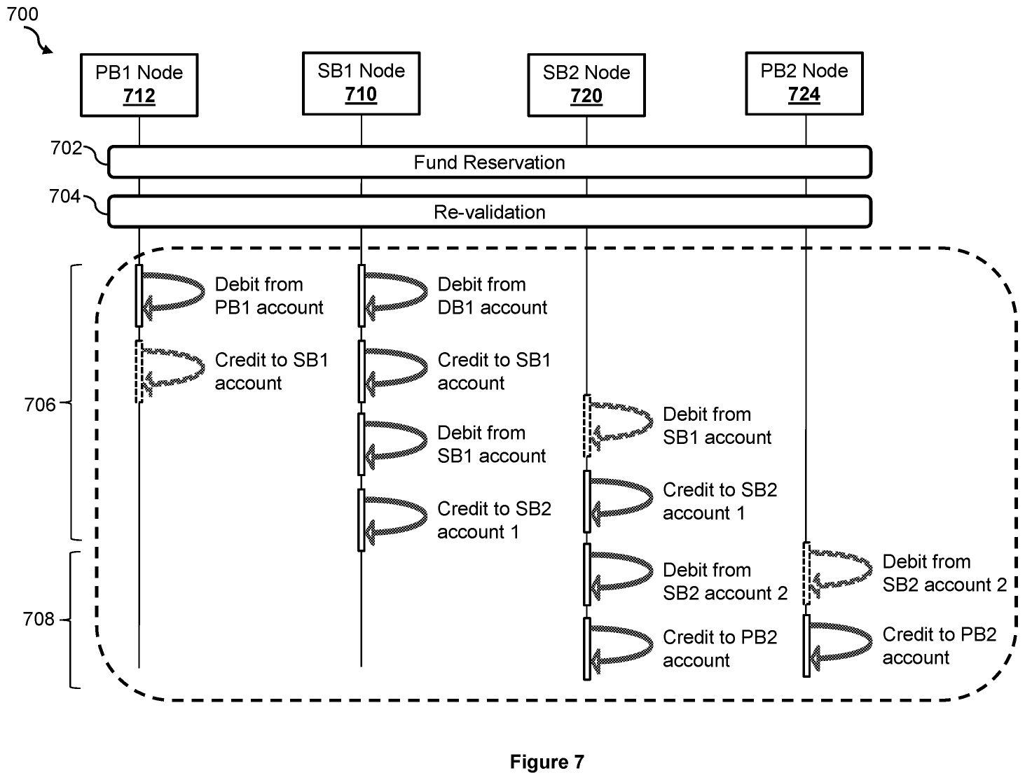

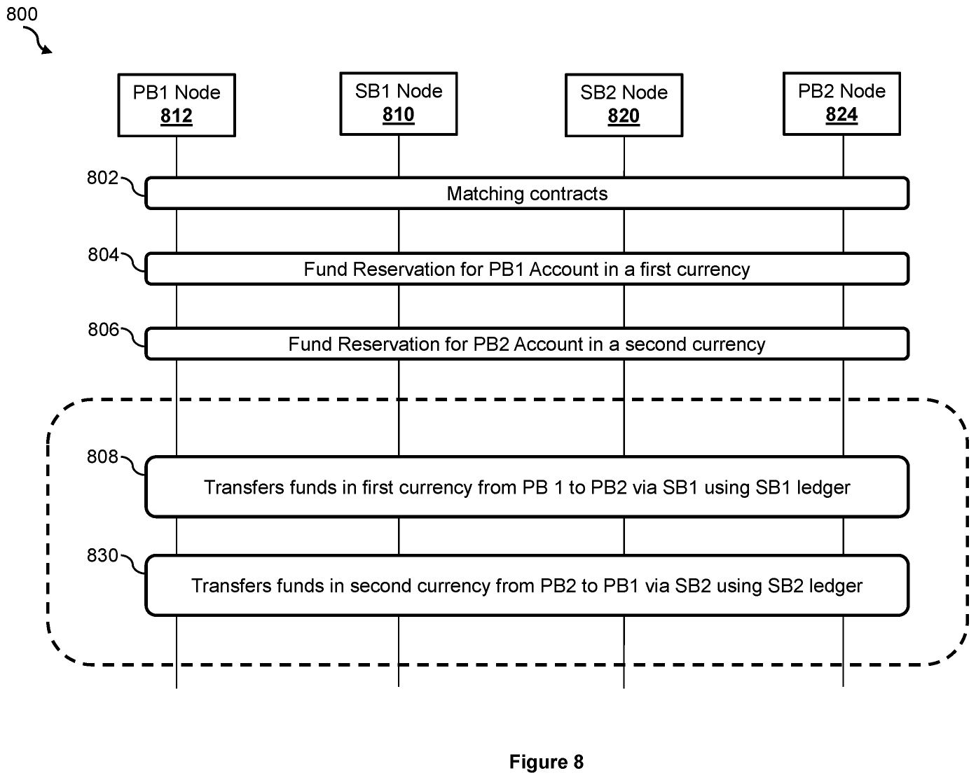

The techniques for performing an atomic transaction for an inter-entity transaction can be applied to use cases other than the ones described above. For example, the same techniques can be used to facilitate funds transfer transactions between entities that have nostro relationships with different settlement entities, foreign exchange transactions between entities, etc., which will be discussed in more details below by reference to FIGS. 7 and 8.

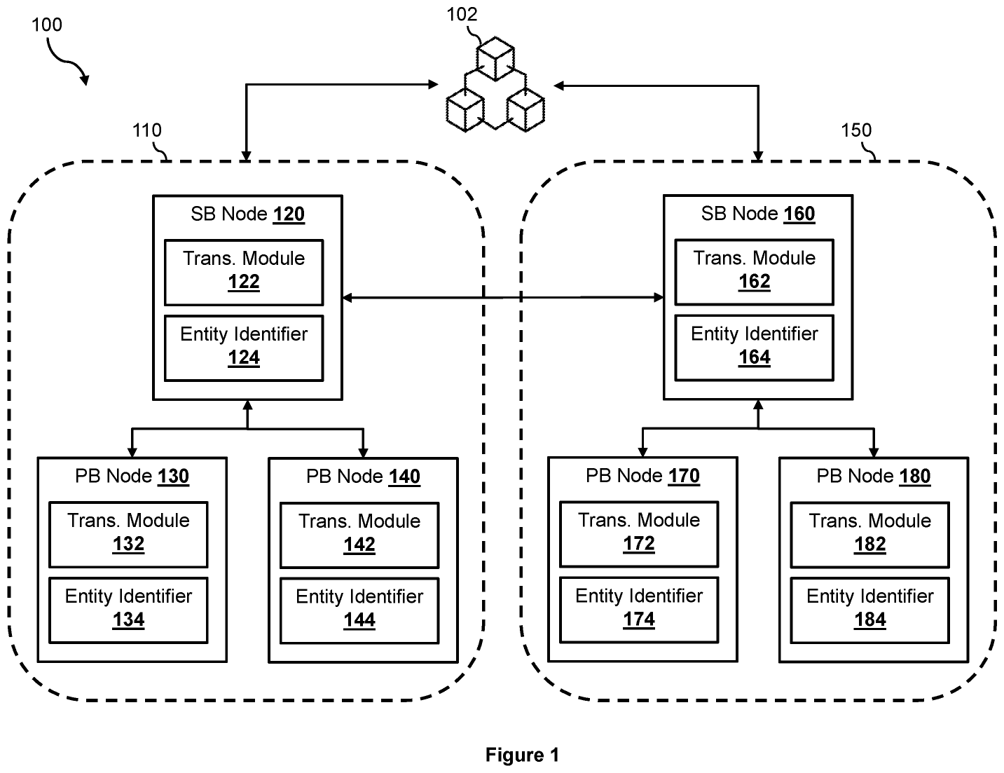

FIG. 1 illustrates a networked system 100, within which the blockchain framework may be implemented according to one embodiment of the disclosure. Note that the present techniques may be applied in many different computing and technological environments, however, and are not limited to those shown in the figures. The networked system 100 includes multiple SB nodes associated with different settlement entities (e.g., settlement banks, etc.), such as SB nodes 120 and 160, multiple PB nodes associated with different participating entities (e.g., participating banks, etc.), such as PB nodes 130, 140, 170, and 180, and a blockchain 102 that may be coupled with each other via a network (not shown). The network may be implemented as a single network or a combination of multiple networks. For example, the network may include the Internet and/or one or more intranets, landline networks, wireless networks, and/or other appropriate types of communication networks. In another example, the network may comprise a wireless telecommunications network (e.g., cellular phone network) adapted to communicate with other communication networks, such as the Internet.

Each of the SB nodes 120 and 160 may be associated with a corresponding settlement entity, and each of the PB nodes 130, 140, 170, and 180 may be associated with a corresponding participating entity. Each node (SB node or PB node) includes a transaction module (that implements the executable program as discussed here) and an entity identifier that identifies the associated entity. For example, the SB node 120 includes a transaction module 122 and an entity identifier 124 that identifies the associated settlement entity, the PB node 130 includes a transaction module 132 and an entity identifier 134 that identifies the associated participating entity, and the PB node 140 includes a transaction module 142 and an entity identifier 144 that identifies the associated participating entity. Similarly, the SB node 160 includes a transaction module 162 and an entity identifier 164 that identifies the associated settlement entity, the PB node 170 includes a transaction module 172 and an entity identifier 174 that identifies the associated participating entity, and the PB node 180 includes a transaction module 182 and an entity identifier 184 that identifies the associated participating entity. Each of the transaction modules 122, 132, 142, 162, 172, and 182 may collaborate with other transaction modules to process inter-entity transfers using the techniques described herein. The entity identifiers may enable the corresponding transaction modules to identify the identity of the associated entity and the role of the associated entity in an inter-entity transaction, such that the transaction modules may perform customized functions for processing the inter-entity transaction for the associated entity.

As discussed herein, entities may have nostro relationships with various settlement entities. Specifically, an entity may have a nostro relationship with a particular settlement entity when the entity has an account with the particular settlement entity. When an entity has an account with a settlement entity and becomes a participating entity for the settlement entity, the settlement entity may manage the account for the participating entity, and facilitate transactions (e.g., inter-entity transactions, etc.) for the account of the participating entity. As shown in FIG. 1, the PB nodes 130 and 140 may be associated with participating entities that have nostro relationships with a settlement entity associated with the SB node 120. As such, the SB node 120 may be used by the corresponding settlement entity to manage accounts of the participating entities associated with the PB nodes 130 and 140 and facilitate inter-entity transactions among its participating entities. The SB node 120 and the PB nodes 130 and 140 is therefore part of a ledger group 110. Similarly, the PB nodes 170 and 180 may be associated with participating entities that have nostro relationships with a settlement entity associated with the SB node 160. As such, the SB node 160 may be used by the corresponding settlement entity to manage accounts of the participating entities associated with the PB nodes 130 and 140 and facilitate inter-entity transactions among its participating entities. The SB node 160 and the PB nodes 170 and 180 is therefore part of another ledger group 150.

While only two SB nodes and four PB nodes are shown in FIG. 1, it has been contemplated that the networked system 100 may include additional SB nodes representing additional settlement entities and additional PB nodes representing additional participating entities. Furthermore, the connections between the SB nodes 120 and 160 and the PB nodes 130, 140, 170, and 180 can be more complex than what is shown in FIG. 1. For example, any one of the PB nodes 130, 140, 170, and 180 may be connected to more than one SB node, indicating that the associated entity has nostro relationships (has accounts) with multiple settlement entities. In addition, any of the settlement entities associated with the SB nodes 120 and 160 can be a participating entity with another settlement entity. For example, the SB node 120 can act as a PB node connecting to the SB node 160, and vice versa, when processing different transactions. In a non-limited example, one of the PB nodes 130 and 140 may be associated with the settlement entity of the SB node 160, and one of the PB nodes 170 and 180 may be associated with the settlement entity of the SB node 120.

In some embodiments, the blockchain 102 is configured to store records of transactions conducted among various participating entities and facilitated by various settlement entities. For example, the transaction module 122 may collaborate with any one or more of the transaction modules 132 and 142 to record transactions that involve accounts associated with the PB nodes 130 and 140 on the blockchain 102. Similarly, the transaction module 162 may collaborate with any one or more of the transaction modules 172 and 182 to record transactions that involve accounts associated with the PB nodes 170 and 180 on the blockchain 102. Each of the transactions recorded on the blockchain may be identified with a smart contract identifier (representing the ledger managed by the corresponding settlement entity) based on the execution of the corresponding smart contracts in processing and/or recording the transactions on the blockchain 102.

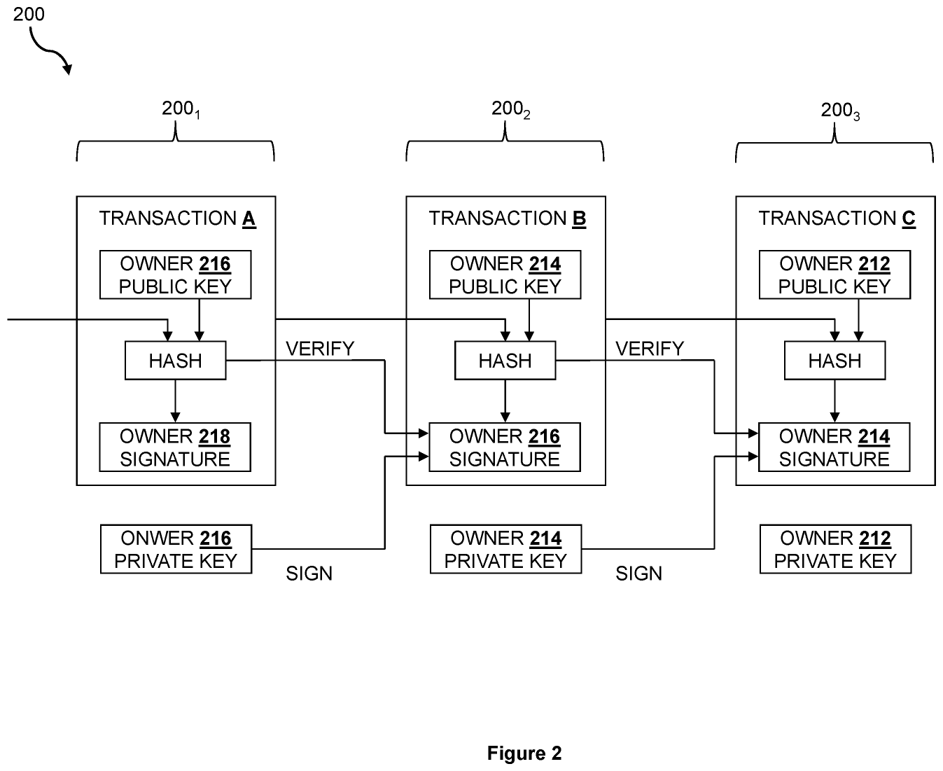

FIG. 2 illustrates an example electronic token 200 that can be used in the blockchain 102 according to one embodiment of the disclosure. The electronic token (or simply as “token”) 200 may be issued by one of the SB nodes 120 and 160, and/or the PB nodes 130, 140, 170, and 180, and may correspond to a monetary amount in a particular currency (e.g., a fiat currency, a digital currency, etc.). As such, inter-entity funds transfer transactions can be represented by transfers of tokens on the blockchain 102. The electronic token 200 is an electronic product that is transferrable among different parties based on a particular protocol. In some embodiments, the electronic token 200 may be defined as a chain of digital signatures provided by previous owners of the electronic token 200 to subsequent owners of the electronic token. In the illustrated embodiment, the electronic token 200 is owned by an owner 212, and FIG. 2 illustrates how the electronic token 200 is defined by the digital signatures of the previous owners 214, 216, and 218. Specifically, in transaction A, a hash of the public key of owner 216 (i.e., the owner receiving, as a result of transaction A, the electronic token 2001 defined by digital signatures provided up to transaction A) and the previous transaction (not illustrated, but occurring prior to transaction A) was signed by owner 218 (i.e., the owner providing, as a result of transaction A, the electronic token 2001 defined by digital signatures provided up to transaction A) using a private key and added to an initial electronic token (which was defined by digital signatures provided up to the transaction prior to transaction A) such that the electronic token 200 was transferred to owner 216.

Similarly, in transaction B, a hash of the public key of owner 214 (i.e., the owner receiving, as a result of transaction B, an electronic token 2002 defined by digital signatures provided up to transaction B) and transaction A was signed by owner 216 using a private key and added to the electronic token 2001 such that the electronic token 200 was transferred to owner 214. Similarly, in transaction C, a hash of the public key of owner 212 (i.e., the owner receiving, as a result of transaction C, the electronic token 2003 defined by digital signatures provided up to transaction C) and the transaction B was signed by owner 214 using a private key and added to the electronic coin 2002 such that the electronic token 200 was transferred to owner 212. As is understood in the art, any payee receiving an electronic token (e.g., owner 216 in transaction A, owner 214 in transaction B, and owner 212 in transaction C) can verify the signatures to verify the chain of ownership of the electronic token 200.

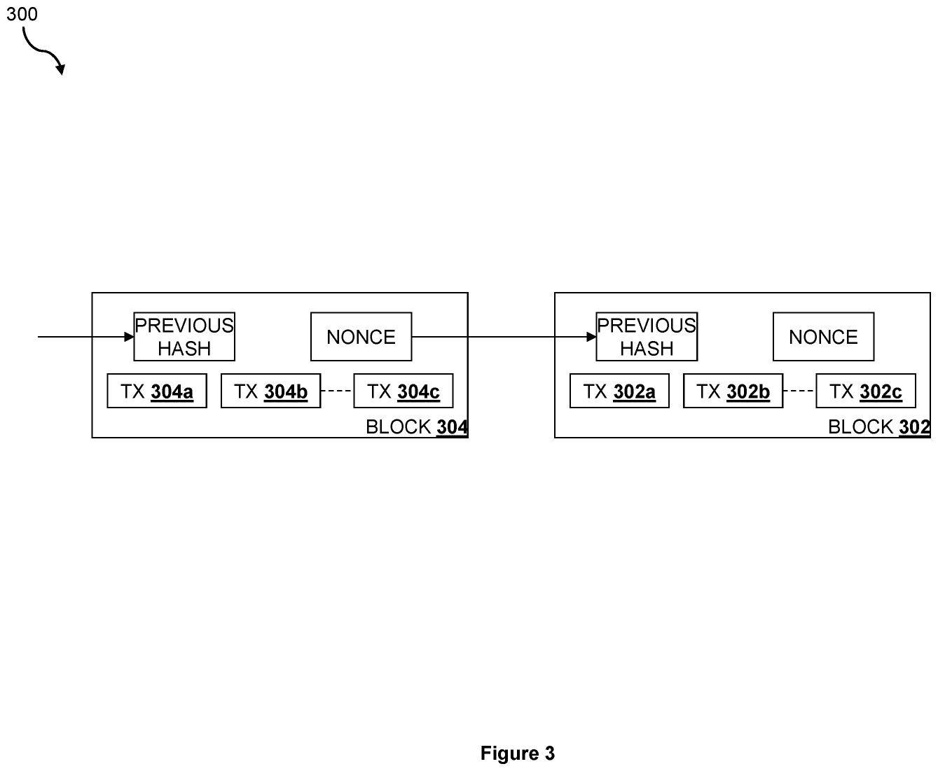

FIG. 3 illustrates an example ledger (or chain) 300 according to one embodiment of the disclosure. The ledger 300 may correspond to the blockchain 102. The ledger 300 operates to verify previous transactions (e.g., transfer) and ownership of electronic tokens (e.g., referring back to FIG. 2, owner 216 in transaction A, owner 214 in transaction B, and owner 212 in transaction C) such that owners did not “double-spend” (e.g., use a private key to sign any previous transactions involving) that electronic token. To produce the ledger 300, a single device or a distributed network of devices (which may include the service provider server 130, the agent node 180, the agent node 190, etc.) may operate to agree on a single history of transactions in the order in which they were received such that it may be determined that a transaction between a transferrer and a transferee of a token is the first transaction associated with that electronic token from the transferrer. Each device in the distributed network operates to collect new transactions into a block, and then to increment a proof-of work system that includes determining a value that when hashed with the block provides a required number of zero bits.

For example, for a block 302 that includes a plurality of transactions 302a, 302b, and up to 302c, a device (also referred to as a “node”) in the distributed network may increment a nonce in the block 302 until a value is found that gives a hash of the block 302 the required number of zero bits. The device may then “chain” the block 302 to the previous block 304 (which may have been “chained” to a previous block, not illustrated, in the same manner). When devices in the distributed network find the proof-of-work for a block, that block (e.g., block 302) is broadcast to the distributed network, and other devices in the distributed network will accept that block if all the transactions in it are valid and not already transferred (which may be determined by creating the next block using the hash of the accepted block 302). The distributed network will always consider the longest chain of blocks to be the correct one and will operate to continue to extend it. In a Proof of Stake (POS) system, a validator that correctly proposed the next block and the proposal is attested by a majority of validators, then the next block would be accepted as the correct one. If a device receives two different versions of a block, it will work on the first block received, but save the second block received in case the branch of the chain that includes the second block becomes longer (at which point that device with switch to working on the branch of the chain that includes the second block).

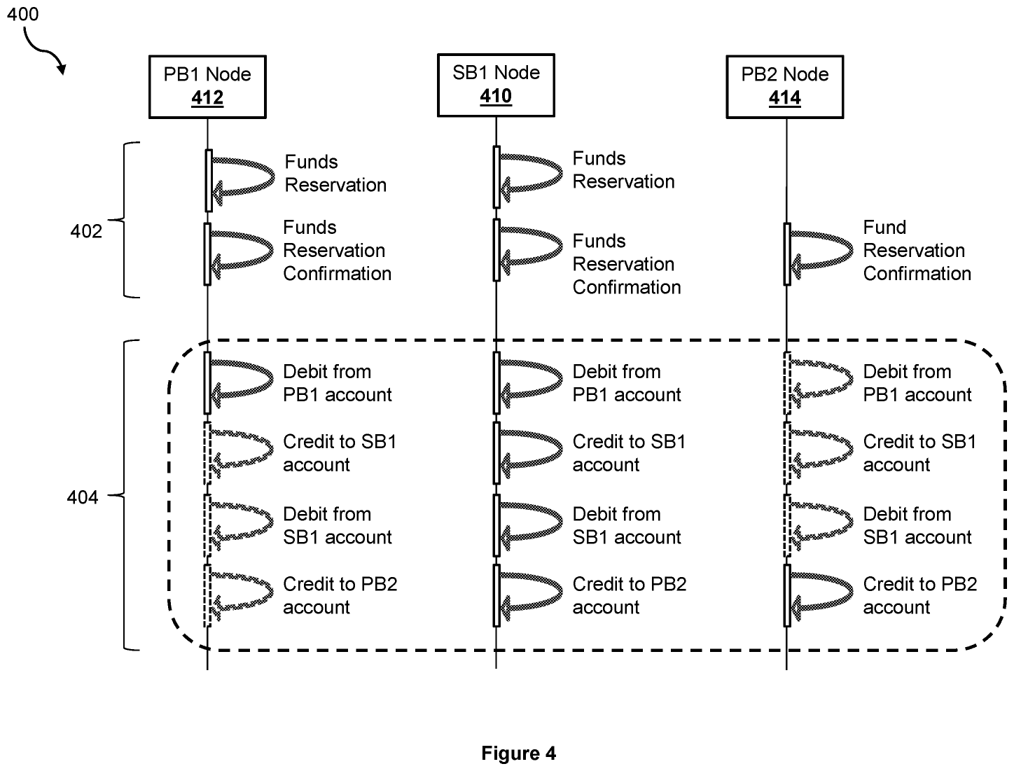

FIG. 4 illustrates example operations 400 performed by various computer nodes in processing an inter-entity funds transfer transaction according to various embodiments of the disclosure. In this example, a first participating entity associated with a PB1 Node 412 has initiated (e.g., using a transaction module associated with the PB1 Node 412) a funds transfer request for transferring funds in a particular amount from a first account of the first participating entity to a second account of a second participating entity associated with a PB2 Node 414. Both of the first participating entity and the second participating entity in this example have nostro relationships with the same settlement entity associated with a SB1 Node 410. As such, the SB1 node 410 may correspond to the SB node 120, and the PB1 node 412 and the PB2 node 414 may correspond to the PB node 130 and the PB node 140, respectively. Each of the SB1 node 410, the PB1 node 412, and the PB2 node 414 may include a corresponding transaction module for executing the functions as discussed herein for the corresponding node.

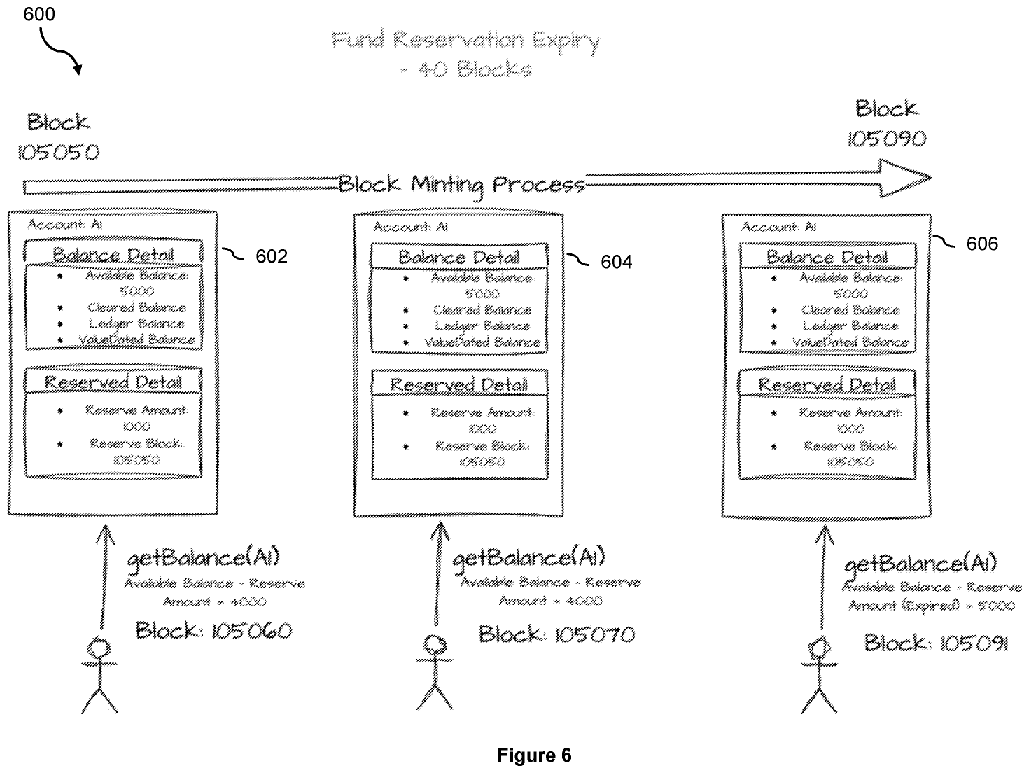

The funds transfer request may be received by the SB1 node 410. After receiving the funds transfer request, the SB1 Node 410 may initiate a funds reservation transaction to reserve the funds in the particular amount from the first account associated with the PB1 node 412 such that the funds cannot be used (e.g., spent) by the first participating entity associated with the PB1 node 412 for a duration (e.g., a number of blocks to be minted on the blockchain 102, etc.). This way, the funds is secured for this funds transfer transaction as long as the transaction is completed before the expiration of the funds reservation. The funds reservation transaction is represented by the group of operations 402 performed by the various nodes in FIG. 4. In some embodiments, according to the group of operations 402, the SB1 node 410 and/or the PB1 node 412 may process the funds reservation transaction on the blockchain 102. When the funds reservation transaction is completed (e.g., executed on the blockchain 102), the SB1 node 410 and/or the PB1 node 412 may receive a funds reservation confirmation. The SB1 node 410 and/or the PB1 node 412 may forward the funds reservation confirmation to the nodes associated with other party (or parties) involved in the funds transfer transaction, such as the PB2 node 414. In some embodiments, the PB2 node 414 may not process (or may abort) the funds transfer transaction if the funds reservation confirmation is not received within a predetermined period of time after the funds transfer request is submitted (e.g., within 5 seconds, within 10 seconds, etc.). Funds reservation transactions will be discussed in more detail below by reference to FIG. 6.

After reserving the funds from the first account associated with the PB1 node 412, the SB1 node 410, the PB1 node, and the PB2 node 414 may collaborate with each other to process the funds transfer transaction, as represented by the group of operations 404. As discussed herein, a funds transfer transaction typically involves multiple steps (or postings) related to changes to accounts associated with the related parties. In this example, the transfer of the funds from the first account to the second account may involve four postings, as indicated by the group 404: a first posting associated with processing a debit of the funds from the first account associated with the PB1 node 412, a second posting associated with processing a credit of the funds to the intermediate account associated with the SB1 node 410, a third posting associated with processing a debit of the funds from the intermediate account associated with the SB1 node 410, and a fourth posting associated with processing a credit of the funds to the second account associated with the PB1 node 414.

In some embodiments, each node (e.g., the transaction module of each node, etc.) may process the postings or a subset of the postings based on a role of the associated entity in the funds transfer transaction. For example, based on an entity identifier stored on the SB1 node 410, the transaction module of the SB1 node 410 may determine that the SB1 node 410 is associated with a settlement entity that manages and facilitates transactions associated with its participating entities. Thus, the SB1 node 410 may process all of the four postings related to the funds transfer transaction, as indicated by the solid arrow associated with all of the four postings under SB1 node 410.

Based on an entity identifier stored on the PB1 node 412, the transaction module of the PB1 node 412 may determine that the PB1 node 412 is associated with the first participating entity that is transferring the funds to the second participating entity in the funds transfer transaction. Thus, the PB1 node 412 may process only a subset of the four postings related to the first account associated with the first participating entity, such as the first posting associated with processing the debit of the funds from the first account, and not the other postings (as indicated by the solid arrow associated with the first posting, and dotted arrows associated with the remaining postings under PB1 node 412). Similarly, based on an entity identifier stored on the PB2 node 414, the transaction module of the PB2 node 414 may determine that the PB2 node 414 is associated with the second participating entity that receives the funds from the first participating entity in the funds transfer transaction. Thus, the PB2 node 414 may process only a subset of the four postings related to the second account associated with the second participating entity, such as the fourth posting associated with processing the credit of the funds to the second account, and not the other postings (as indicated by the solid arrow associated with the fourth posting, and dotted arrows associated with the remaining postings under PB2 node 414). In some embodiments, the SB1 node 410, the PB1 node 412, and the PB2 node 414 also processes the funds transfer transaction as a single atomic transaction on the blockchain 102, such that the funds transfer transaction is recorded on the blockchain 102. The atomic transaction that is recorded on the blockchain 102 may indicate a funds transfer transaction has been conducted between the accounts associated with the PB1 node and the PB2 node, but may not include any additional information associated with the transaction. The additional information may be stored, instead, on the public data storages and the private data storages of the PB1 node 412, the SB1 node 410, and the PB2 node 414, as will be explained in more detail below.

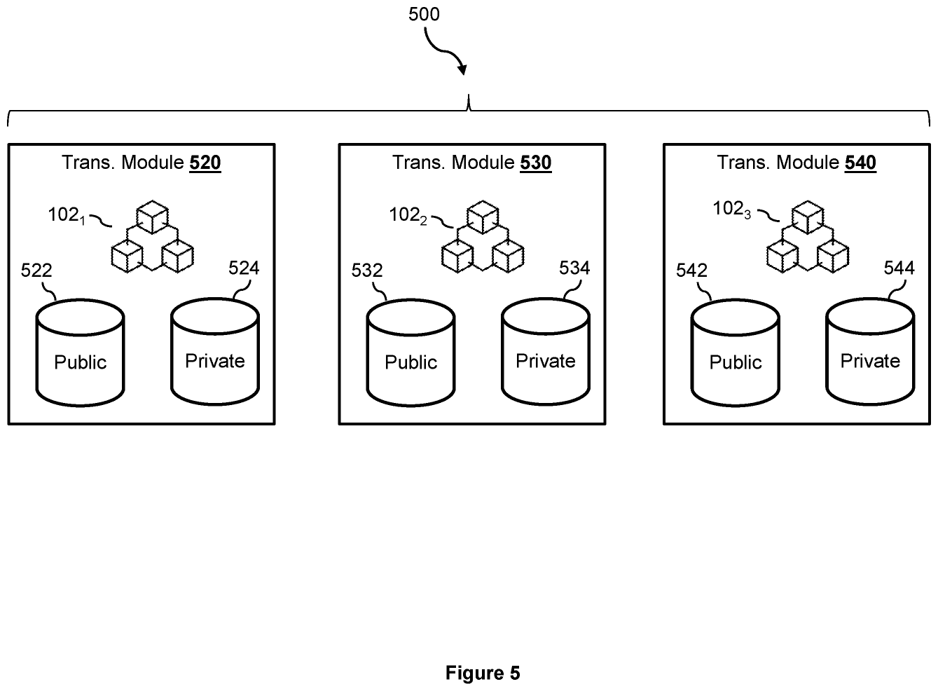

FIG. 5 is a block diagram illustrating components of different transaction modules according to various embodiments of the disclosure. In some embodiments, the transaction module 520 is implemented within the PB1 node 412, the transaction module 530 is implemented within the SB1 node 410, and the transaction module 540 is implemented within the PB2 node 414. As shown, each of the transaction modules 520, 530, and 540 is associated with a copy of the blockchain 102. For example, the transaction module 520 is associated with a blockchain copy 1021, the transaction module 530 is associated with a blockchain copy 1022, and the transaction module 540 is associated with a blockchain copy 1023. Each of the blockchain copies 1021, 1022, and 1023 is managed by the respective transaction module and is consistent with each other and with the blockchain 102. In addition, each of the transaction modules 520, 530, and 540 also includes a public data storage and a private data storage. For example, the transaction module 520 has a public data storage 522 and a private data storage 524, the transaction module 530 has a public data storage 532 and a private data storage 534, and the transaction module 540 has a public data storage 542 and a private data storage 544.

In some embodiments, the transaction modules 520, 530, and 540 perform different functions to collaborate in the processing of the funds transfer transaction that transfers the funds from the first account associated with the PB1 node 412 to the second account associated with the PB2 node 414. For example, each of the transaction modules 520, 530, and 540 may perform the necessary functions (e.g., functions related to a consensus mechanism associated with the blockchain 102, recording the transaction in a record and storing adding the record on the corresponding blockchain copy, and synchronizing the blockchain copy with other computer nodes, etc.) to record the funds transfer transaction that transfers the funds from the first account to the second account as a single atomic transaction on the blockchain 102. The transaction that is recorded on the blockchain 102 may include only limited information that represents the funds transfer transaction, such as identities of the entities involved in the funds transfer transaction, a transaction identifier, etc. However, since the blockchain 102 is distributed and can be accessed by other entities (e.g., other computer nodes within the blockchain network, etc.), the transaction modules 520, 530, and 540 may not include other information such as an amount associated with the funds being transferred in the funds transfer transaction, balances of the first and second accounts etc., in the record of the blockchain 102, such that the privacy of different entity accounts can be maintained.

The other information associated with the funds transfer transaction and the accounts may be stored in the various public data storages and private data storages of the transaction modules 520, 530, and 540, as dictated by the transaction modules 520, 530, and 540. For example, since the transaction module 530 is associated with a settlement entity and processes all of the postings associated with the funds transfer transaction, the transaction module 530 may store information related to the postings in the public data storage 532 and/or the private data storage 534. For example, the transaction module 530 may store additional information associated with the funds transfer transaction, such as information associated with any related transactions, a description of the funds transfer transaction, etc. The transaction module 530 may also store, in the private data storage 534, information associated with the postings in the private data storage 534, such as the transaction amount in the funds transfer transaction, updated balances of the first and second accounts associated with the PB1 node 412 and the PB2 node 414, the changes in the balance for the intermediary account associated with the SB1 node 410, and other private information.

Each of the transaction modules 520 and 540 may also store the public information (the information stored by the transaction module 530 in the public data storage 532) in the corresponding public data storage. In addition, the transaction module 520 may store, in the private data storage 524, information pertinent to the first account associated with the PB1 node 412, such as the transaction amount associated with the funds transfer transaction, the processing of the debit of the funds from the first account, and the updated account balance of the first account, etc. Similarly, the transaction module 540 may store, in the private data storage 544, information pertinent to the second account associated with the PB2 node 414, such as the transaction amount associated with the funds transfer transaction, the processing of the credit of the funds to the second account, and the updated account balance of the second account, etc.

By storing only limited (e.g., essential) information of a transaction on the blockchain 102, and selectively storing different private and public data for each node based on the role of the associated entity in the transaction, the blockchain framework enables atomic processing funds transfer transactions on the blockchain 102 and ensures that privacy of different entities is maintained.

FIG. 6 illustrates the effects of a funds reservation transaction on a blockchain at various points in time according to various embodiments of the disclosure. In this example, a computer node (e.g., the SB1 node 410, the PB1 node 412, etc.) may initiate and record a funds reservation transaction associated with a digital wallet of the first bank on the blockchain 102. As discussed herein, the funds reservation transaction may be implemented as a smart contract, and may be associated with an amount of funds to be reserved and an expiration time. In this example, the funds reservation transaction may be associated with an amount of $1,000 and a period of forty blocks. In other words, $1,000 of funds will be withheld from being available to use for the digital wallet associated with the entity for a duration of forty blocks.

In this example, the funds reservation transaction may be executed (e.g., recorded) in a block 602 having a block number of ‘105050’. As such, the $1,000 should be reserved from the account associated with the entity (e.g., the first participating entity, etc.) until a block 606 having a block number ‘105090’. In other words, the $1,000 will not appear as available funds for the account when transactions are conducted (e.g., recorded) in the blocks having block numbers from ‘105050’ to ‘105090.’ At the time that the funds reservation transaction is executed, the account associated with the entity may have a balance of $5,000. However, since $1,000 has been reserved (e.g., become unavailable for use), an inquiry to the balance of the account (e.g., executing a ‘getBalance( )’ command) would result in a response of $4,000). Similarly, if another inquiry to the balance of the account is made at block 604 having a block number ‘105070’ is minted, a response of $4,000 will be provided even through the balance of the account is $4,000 since the $1,000 is still being reserved based on the initial funds reservation transaction. However, when the block 606 having the block number ‘105090’ is minted, the $1,000 is no longer reserved as the funds reservation executed in the block 602 has expired. As a result, an inquiry to the balance of the account when the block 606 is minted would result in a response of $5,000. Thus, after initiating the funds reservation transaction, the transaction modules 520, 530, and 540 must execute the transaction before the expiration of the funds reservation.

FIG. 7 illustrates example operations 700 performed by various computer nodes in processing another inter-entity funds transfer transaction according to various embodiments of the disclosure. In this example, a first participating entity associated with a PB1 Node 712 has initiated (e.g., using a transaction module associated with the PB1 node 712) a funds transfer request for transferring funds in a particular amount from a first participating account of the first participating entity to a second participating account of a second participating entity associated with a PB2 Node 724. Unlike the example described above with respect to FIG. 4, each of the first participating entity and the second participating entity has a nostro relationship with a different settlement entity. For example, the first participating entity may have a nostro relationship with a first settlement entity associated with a SB1 node 710, and the second participating entity may have a nostro relationship with a second settlement entity associated with a SB2 node 720. In addition, the second settlement entity also has a nostro relationship with the first settlement entity (e.g., has an account with the first settlement entity). As such, the SB1 node 710 may correspond to the SB node 120, the SB2 node 720 may correspond to the SB node 160 and the PB node 140, the PB1 node 712 may correspond to the PB node 130, and the PB2 node 724 may correspond to the PB node 180. Each of the SB1 node 710, the SB2 node 720, the PB1 node 712, and the PB2 node 724 may include a corresponding transaction module for executing the functions as discussed herein for the corresponding node.

The funds transfer request may be received by the SB1 node 710. After receiving the funds transfer request, the SB1 Node 710 may initiate a funds reservation transaction 702 to reserve the funds in the particular amount from the first participating account associated with the PB1 node 712 such that the funds cannot be used (e.g., spent) by the first participating entity associated with the PB1 node 712 for a duration (e.g., a number of blocks to be minted on the blockchain 102, etc.). This way, the funds is secured for this funds transfer transaction as long as the transaction is completed before the expiration. When the funds reservation transaction is completed (e.g., executed on the blockchain 102), the SB1 node 710 and/or the PB1 node 712 may receive a funds reservation confirmation. The SB1 node 710 and/or the PB1 node 712 may forward the funds reservation confirmation to the nodes associated with other party (or parties) involved in the funds transfer transaction, such as the SB2 node 720 and the PB2 node 724. In some embodiments, the SB2 node 720 and/or the PB2 node 724 may not process (or may abort) the funds transfer transaction if the funds reservation confirmation is not received within a predetermined period of time after the funds transfer request is submitted (e.g., within 5 seconds, within 10 seconds, etc.).

In some embodiments, after receiving the funds reservation confirmation from SB1 node 710, the SB2 node 720 initiates a re-validation process 704 for the funds transfer transaction. Since the processing of the funds transfer transaction in this example involves updating two different ledgers managed by two different settlement entities on the blockchain 102, the two settlement entities need to ensure that both ledgers are updated or failed to update together. The re-validation process 704 includes generating a multi-signature contract that requires signatures (e.g., generated using the private keys associated with the SB1 node 710 and the SB2 node 720) from both of the SB1 node 710 and the SB2 node 720. Specifically, the fund reservation confirmation from SB1 node 710 registers a first signature associated with the SB1 node 710 in the multi-signature smart contract and the re-validation process 704 initiated by SB2 node 720 includes a signature associated with the SB2 node 720 which is captured by the multi-signature contract. Once the multi-signature contract receives the required signatures from both of the SB1 node 710 and the SB2 node 720, (e.g., the multi-signature smart contract is executed), the processing of an atomic transaction corresponding to the ledgers managed by the SB1 node 710 and the SB2 node 720, respectively, will be triggered.

Since this funds transfer transaction involves two settlement entities, the number of postings required to perform the funds transfer transaction is larger than the postings required in the example illustrated in FIG. 4. Specifically, in this example, the transfer of the funds from the first participating account to the second participating account may involve six postings, as indicated by the groups 706 and 708. The first group 706 is associated with a first ledger managed by the SB1 node 710, and the second group 708 is associated with a second ledger managed by the SB2 node 720. In this example, the first group 706 includes: a first posting associated with processing a debit of the funds from the first participating account associated with the PB1 node 712, a second posting associated with processing a credit of the funds to a first intermediate account associated with the SB1 node 710, a third posting associated with processing a debit of the funds from the first intermediate account associated with the SB1 node 710, and a fourth posting associated with processing a credit of the funds to a second intermediary account associated with the SB2 node 720. When processing the postings in the first group 706, the second settlement entity associated with the SB2 node 720 acts as a participating entity with the first settlement entity associated with the SB1 node 710. The second group 708 includes: a first posting associated with processing a debit of the funds from the second intermediary account associated with the SB2 node 720 and a second posting associated with a credit of the funds to the second participating account associated with the PB2 node 724.

In some embodiments, each node (e.g., the transaction module of each node, etc.) may process the postings or a subset of the postings based on a role of the associated entity in the funds transfer transaction. For example, based on an entity identifier stored on the SB1 node 710, the transaction module of the SB1 node 710 may determine that the SB1 node 710 is associated with a settlement entity that manages and facilitates transactions associated with the participating entities associated with the PB1 node 712 and the SB2 node 720. Thus, the SB1 node 710 may process all of the four postings in the first group of actions 706, as indicated by the solid arrow associated with all of the four postings under SB1 node 710.

Based on an entity identifier stored on the PB1 node 712, the transaction module of the PB1 node 712 may determine that the PB1 node 712 is associated with the first participating entity that is transferring the funds to the second participating entity in the funds transfer transaction. Thus, the PB1 node 712 may process only a subset of the postings related to the first participating account associated with the first participating entity, such as the posting associated with processing the debit of the funds from the first participating account, and not the other postings (as indicated by the solid arrow associated with the first posting, and dotted arrows associated with the remaining postings under PB1 node 712).

Based on an entity identifier stored on the SB2 node 720, the transaction module of the SB2 node 720 may detect that the SB2 node 720 is associated with the second settlement entity that has a nostro relationship with the first settlement entity, and is configured to manage and facilitate transactions associated with the participating entity associated with the PB2 node 724. Thus, the SB2 node 720 may process a subset of the postings associated with the first ledger and related to the second intermediary account, such as the posting associated with processing the credit of the funds to the second intermediary account, and all of the postings associated with the second ledger, such as the posting associated with processing the debit of the funds from the second intermediary account and the posting associated with the credit of the funds to the second participating account associated with the PB2 node 724.

In some embodiments, the SB1 node 710, the SB2 node 720, the PB1 node 712, and the PB2 node 724 also processes the funds transfer transaction as a single atomic transaction on the blockchain 102 for the two ledgers, such that the funds transfer transaction is recorded on both of the ledgers associated with the SB1 node 710 and the SB2 node 720 on the blockchain 102. Even though multiple ledgers are required to be updated in this funds transfer transaction, since both ledgers are implemented within a single blockchain, the transaction for updating the two ledgers can be advantageously performed in a single atomic transaction for the blockchain 102. In addition to recording the transaction on the blockchain 102, each of the PB1 node 712, the SB1 node 710, the SB2 node 720, and the PB2 node 724 may store additional information associated with the funds transfer transaction in the respective public data storages and private data storages using the techniques discussed herein.

FIG. 8 illustrates example operations 800 performed by various computer nodes in processing an inter-entity foreign exchange (currency exchange) transaction according to various embodiments of the disclosure. In this example, a first participating entity associated with a PB1 node 812 and a second participating entity associated with a PB2 node 824 have initiated (e.g., using respective transaction modules associated with the PB1 node 812 and the PB2 node 824) a foreign exchange request for exchanging funds from a first participating account associated with the PB1 node 812 in a first currency (e.g., Singapore Dollars, a first cryptocurrency, etc.) with funds from a second participating account associated with the PB2 node 824 in a second currency (e.g., U.S. Dollars, a second cryptocurrency, etc.). Each of the first participating entity and the second participating entity in this example has nostro relationships two settlement entities. Each of the two settlement entities may be configured to manage and facilitate transactions in a corresponding currency. For example, a first settlement entity associated with a SB1 node 810 may manage and facilitate transactions among its participating entities in a first currency (e.g., Singapore Dollars, a first cryptocurrency, etc.), and a second settlement entity associated with a SB2 node 824 may manage and facilitate transactions among its participating entities in a second currency (e.g., U.S. Dollars, a second cryptocurrency, etc.).

In this example, the first participating entity may have an account (e.g., a first currency account) in a first currency with the first settlement entity associated with the SB1 node 810, and another account (e.g., a second currency account) in a second currency with the second settlement entity associated with the SB2 node 820. Similarly, the second participating entity may have an account (e.g., a first currency account) in the first currency with the first settlement entity associated with the SB1 node 810, and another account (e.g., a second currency account) in the second currency with the second settlement entity associated with the SB2 node 820. As such, the SB1 node 810 may correspond to the SB node 120 in FIG. 1, the SB2 node 820 may correspond to the SB node 160 in FIG. 1, the PB1 node 812 may correspond to the PB node 130 and the PB node 170 in FIG. 1, and the PB2 node 824 may correspond to the PB node 140 and the PB node 180 in FIG. 1. Each of the SB1 node 710, the SB2 node 720, the PB1 node 712, and the PB2 node 724 may include a corresponding transaction module for executing the functions as discussed herein for the corresponding node.

In this foreign exchange transaction, the first participating entity would transfer funds in the first currency to the second participating entity, and the second participating entity would transfer funds in the second currency to the first participating entity. In some embodiments, to initiate the foreign exchange transaction, each of the PB1 node 812 and PB2 node 824 transmits a foreign exchange request to the computer nodes associated with the settlement entities (e.g., the SB1 node 810 and the SB2 node 820).

After receiving the requests generated by the PB1 node 812 and the PB2 node 824, the SB1 node 810 and/or the SB2 node 820 may perform contract matching 802 based on the two requests. For example, the SB1 node 810 and/or the SB2 node 820 may determine whether the parties of the transaction indicated in both of the requests match with each other, and whether the amount of funds in the first currency indicated in the requests correspond to the amount of funds in the second currency based on an exchange rate, and other information indicated in the requests. If the SB1 node 810 and/or the SB2 node 820 determines that the information in the requests do not match, the SB1 node 810 and/or the SB2 node 820 may abort the foreign exchange transaction. For example, the SB1 node 810 and/or the SB2 node 820 may deny the foreign exchange request and send a transaction failure message to the PB1 node 812 and the PB2 node 824.

If the SB1 node 810 and/or the SB2 node 820 determines that the information in the requests match, the SB1 node 810 and the SB2 node 820 would initiate one or more funds reservation transactions to reserve the respective funds from the first currency account of the first participating entity and the second currency account of the second participating entity. For example, the SB1 node 810 and the PB1 node 812 may initiate a funds reservation request 804 on the blockchain 102 for reserving an amount of funds indicated in the foreign transaction request in the first currency from the first currency account of the first participating entity. Similarly, the SB2 node 820 and the PB2 node 824 may initiate another funds reservation request 806 on the blockchain 102 for reserving an amount of funds indicated in the foreign transaction request in the second currency from the second currency account of the second participating entity. The executions of the funds reservation requests enable the respective funds from the accounts of the first participating entity and the second participating entity to be reserved for a duration of time (e.g., a number of blocks on the blockchain), which prevents a failure of the foreign exchange transaction when one or more of the accounts lack sufficient funds at the time when the foreign exchange transaction is processed.

When the funds reservation transaction 804 is completed (e.g., executed on the blockchain 102), the SB1 node 810 and/or the PB1 node 812 may receive a funds reservation confirmation. The SB1 node 810 and/or the PB1 node 812 may forward the funds reservation confirmation to the nodes associated with other party (or parties) involved in the funds transfer transaction, such as the SB2 node 820 and the PB2 node 824. In some embodiments, the SB2 node 820 and/or the PB2 node 824 may not process (or may abort) the foreign exchange transaction if the funds reservation confirmation is not received within a predetermined period of time after the funds transfer request is submitted (e.g., within 5 seconds, within 10 seconds, etc.).

Similarly, when the funds reservation transaction 806 is completed (e.g., executed on the blockchain 102), the SB2 node 820 and/or the PB2 node 824 may receive a funds reservation confirmation. The SB2 node 820 and/or the PB2 node 824 may forward the funds reservation confirmation to the nodes associated with other party (or parties) involved in the funds transfer transaction, such as the SB1 node 810 and the PB1 node 812. In some embodiments, the SB1 node 810 and/or the PB1 node 812 may not process (or may abort) the foreign exchange transaction if the funds reservation confirmation is not received within a predetermined period of time after the funds transfer request is submitted (e.g., within 5 seconds, within 10 seconds, etc.).

In some embodiments, after receiving the funds reservation confirmation from the SB1 node 810, the SB2 node 820 initiates a re-validation process for the foreign exchange transaction. Since the processing of the foreign exchange transaction in this example involves updating two different ledgers managed by two different settlement entities, the two settlement entities need to ensure that both entities will update the respective ledgers together. The re-validation process includes generating a multi-signature contract that requires signatures (e.g., generated using the private keys associated with the SB1 node 810 and the SB2 node 820) from both of the SB1 node 810 and the SB2 node 820. Specifically, the fund reservation confirmation from SB1 node 810 registers a first signature associated with the SB1 node 810 in the multi-signature smart contract and the re-validation process initiated by SB2 node 820 includes a second signature associated with the SB2 node 820 which is captured by the multi-signature contract. Once the multi-signature contract receives the required signatures from both of the SB1 node 710 and the SB2 node 720, (e.g., the multi-signature smart contract is executed), the processing of an atomic transaction corresponding to the ledgers managed by the SB1 node 810 and the SB2 node 820, respectively, will be triggered. Even though multiple ledgers are required to be updated in this funds transfer transaction, since both ledgers are implemented within a single blockchain, the transaction for updating the two ledgers can be advantageously performed in a single atomic transaction for the blockchain 102.

In this example, the exchange of funds in different currencies between the first participating account and the second participating account may involve eight postings, represented by the groups 808 and 830 in FIG. 8. The first group 808 includes postings that are associated with a first ledger managed by the SB1 node 810, and the second group 830 includes postings that are associated with a second ledger managed by the SB2 node 820. In this example, the first group 808 includes: a first posting associated with processing a debit of the funds in the first currency from the first participating account associated with the PB1 node 812, a second posting associated with processing a credit of the funds in the first currency to a first intermediate account associated with the SB1 node 810, a third posting associated with processing a debit of the funds in the first currency from the first intermediate account associated with the SB1 node 810, and a fourth posting associated with processing a credit of the funds in the first currency to the second participating account associated with the PB2 node 824. The second group 830 includes: a first posting associated with processing a debit of the funds from the second participating account associated with the SB2 node 720 and a second posting associated with a credit of the funds to the second participating account associated with the PB2 node 724.

In some embodiments, each node (e.g., the transaction module of each node, etc.) may process the postings or a subset of the postings based on a role of the associated entity in the foreign exchange transaction. For example, based on an entity identifier stored on the SB1 node 810, the transaction module of the SB1 node 810 may determine that the SB1 node 810 is associated with a settlement entity that manages and facilitates transactions associated with the participating entities associated with the PB1 node 812 and the PB2 node 824 in the first currency. Thus, the SB1 node 810 may process all of the four postings in the first group 808.

Based on an entity identifier stored on the PB1 node 812, the transaction module of the PB1 node 812 may determine that the PB1 node 812 is associated with the first participating entity that is transferring funds in the first currency to the second participating entity and receiving funds in the second currency from the second participating entity in the foreign exchange transaction. Thus, the PB1 node 812 may process a subset of the postings in the group 808, such as the posting associated with processing the debit of the funds in the first currency from the first currency account of the first participating entity in association with the first ledger, and may process a subset of the postings in the group 810, such as the posting associated with processing the credit of the funds in the second currency to the second currency account of the first participating entity in association with the second ledger.

Based on an entity identifier stored on the PB2 node 824, the transaction module of the PB2 node 824 may determine that the PB2 node 824 is associated with the second participating entity that is transferring funds in the second currency to the first participating entity and receiving funds in the first currency from the first participating entity in the foreign exchange transaction. Thus, the PB2 node 824 may process a subset of the postings in the group 808, such as the posting associated with processing the credit of the funds in the first currency to the first currency account of the second participating entity in association with the first ledger, and may process a subset of the postings in the group 810, such as the posting associated with processing the debit of the funds in the second currency from the second currency account of the second participating entity in association with the second ledger.

In some embodiments, the SB1 node 810, the SB2 node 820, the PB1 node 812, and the PB2 node 824 also processes the foreign exchange transaction as a single atomic transaction on the blockchain 102 for the two ledgers, such that the foreign exchange transaction is recorded on both of the ledgers associated with the SB1 node 810 and the SB2 node 820 on the blockchain 102. Even though multiple ledgers are required to be updated in this funds transfer transaction, since both ledgers are implemented within a single blockchain, the transaction for updating the two ledgers can be advantageously performed in a single atomic transaction for the blockchain 102. In addition to recording the transaction on the blockchain 102, each of the PB1 node 812, the SB1 node 810, the SB2 node 820, and the PB2 node 824 may store additional information associated with the foreign exchange transaction in the respective public data storages and private data storages using the techniques discussed herein.

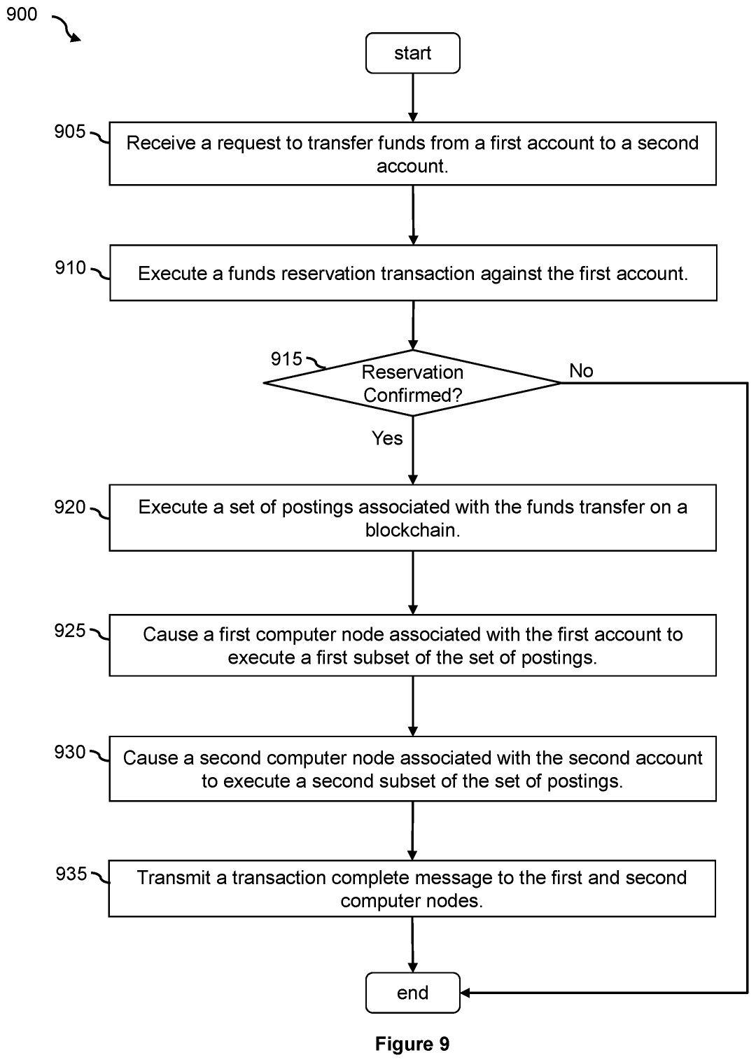

FIG. 9 illustrates a process 900 for performing an inter-entity funds transfer transaction on a blockchain according to various embodiments of the disclosure. Specifically, the process 900 is related to an inter-entity funds transfer transaction where both participating entities have nostro relationships with the same settlement entity. In some embodiments, at least a portion of the process 900 may be performed by the transaction module of one or more computer nodes within a blockchain network. The process 900 begins by receiving (at step 905) a request to transfer funds from a first account to a second account. For example, a computer node associated with a settlement entity (e.g., the SB node 120) may receive a funds transfer request from another computer node associated with one of its participating entities (e.g., the PB node 130 of a first participating entity). The funds transfer request may specify transferring funds in a particular amount from a first account of the first participating entity to a second account of a second participating entity.

Based on the request, the process 900 includes the step of executing (at step 910) a funds reservation transaction against the first account. For example, the SB node 120 and the PB node 130 may initiate a funds reservation transaction on the blockchain 102, where funds of the particular amount specified in the funds transfer request is reserved on the blockchain 102 for a duration (e.g., a number of blocks on the blockchain 102). Upon a successful execution of the funds reservation transaction, the SB node 120 may receive a funds reservation confirmation.

At step 915, the SB node 120 determines whether the funds reservation confirmation is received. If the funds reservation confirmation is not received, the process 900 ends. However, if the funds reservation confirmation is received, the SB node 120 may collaborate with computer nodes involved in the funds transfer transaction (e.g., the PB node 130, the PB node 140 associated with the second account, etc.) to process the funds transfer transaction on the blockchain 102. For example, at step 920, the SB node 120 may execute a set of postings associated with the funds transfer on the blockchain 102. The set of postings may include postings associated with changes in different accounts involved in the funds transfer transaction. In some embodiments, the set of postings may include a first posting associated with processing a debit of the funds from the first account associated with the PB node 130, a second posting associated with processing a credit of the funds to the intermediate account associated with the SB node 120, a third posting associated with processing a debit of the funds from the intermediate account associated with the SB node 120, and a fourth posting associated with processing a credit of the funds to the second account associated with the PB node 140.

The SB node 120 may also causes (at step 925) the PB node 130 associated with the first account to execute a first subset of the set of postings, such as the first posting associated with processing a debit of the funds from the first account associated with the PB node 130. The SB node 120 may also causes (at step 930) the PB node 140 associated with the second account to execute a second subset of the set of postings, such as the fourth posting associated with processing a credit of the funds to the second account associated with the PB node 140. In some embodiments, the SB node 120, the PB node 130, and the PB node 140 (and possibly other computer nodes associated with the blockchain network) may collaborate with each other to process a single atomic transaction associated with the funds transfer on the blockchain 102.

After completing the funds transfer transaction, the SB node 120 may transmit (at step 935) a transaction complete message to the other computer nodes involved in the transaction, such as the PB node 130 and the PB node 140.

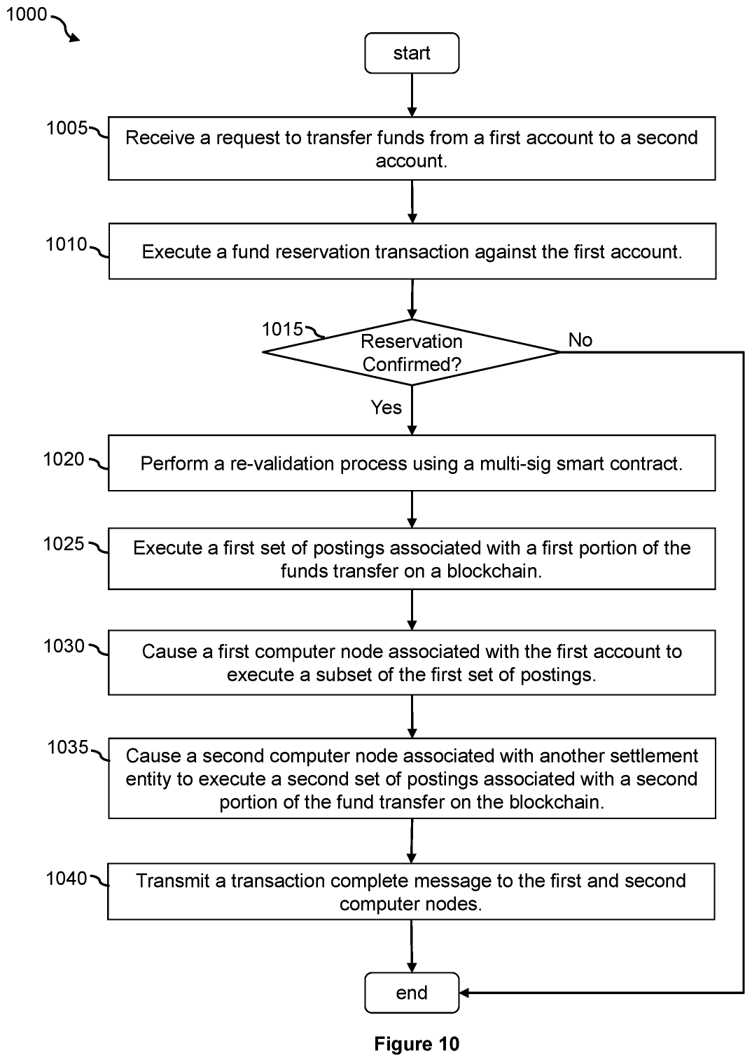

FIG. 10 illustrates a process 1000 for performing another inter-entity funds transfer transaction on a blockchain according to various embodiments of the disclosure. In some embodiments, at least a portion of the process 1000 may be performed by the transaction module of one or more computer nodes within a blockchain network. Unlike the process 900, the process 1000 is related to an inter-entity funds transfer when the participating entities have nostro relationships with different settlement entities. The process 1000 begins by receiving (at step 1005) a request to transfer funds from a first account to a second account. For example, a computer node associated with a first settlement entity (e.g., the SB node 120) may receive a funds transfer request from another computer node associated with one of its participating entities (e.g., the PB node 130 of a first participating entity). The funds transfer request may specify transferring funds in a particular amount from a first account of the first participating entity to a second account of a second participating entity.

Based on the request, the process 1000 includes the step of executing (at step 1010) a funds reservation transaction against the first account. For example, the SB node 120 and the PB node 130 may initiate a funds reservation transaction on the blockchain 102, where funds of the particular amount specified in the funds transfer request is reserved on the blockchain 102 for a duration (e.g., a number of blocks on the blockchain 102). Upon a successful execution of the funds reservation transaction, the SB node 120 may receive a funds reservation confirmation.

At step 1015, the SB node 120 determines whether the funds reservation confirmation is received. If the funds reservation confirmation is not received, the process 1000 ends. However, if the funds reservation confirmation is received, the SB node 120 may collaborate with computer nodes involved in the funds transfer transaction to process the funds transfer transaction on the blockchain 102. In some embodiments, based on the funds transfer request, the SB node 120 may determine that the recipient account is associated with a second participating entity that does not have a nostro relationship with the settlement entity associated with the SB node 120. The SB node 120 may determine that the second participating entity has a nostro relationship with another settlement entity (e.g., a second settlement entity), which in turn has a nostro relationship with the first settlement entity. As such, the SB node 120 may collaborate with the PB 130, the SB node 160 associated with the second settlement entity, and the PB node 170 associated with the second participating entity to process the funds transfer transaction. The SB node 120 may send the funds reservation confirmation to both the PB 130 and the SB 160.

Since the processing of the funds transfer transaction in this example requires updates to two different ledgers managed by different settlement entities (e.g., a first ledger managed by the SB node 120 and a second ledger managed by the SB node 160), the updates to the two ledgers need to be processed together (or fail together). As such, the SB node 120 and/or the SB node 160 may perform (at step 1020) a re-validation process using a multi-signature smart contract. For example, the SB node 120 and/or the SB node 160 may generate and execute a multi-signature smart contract that requires digital signatures from both of the SB node 120 and the SB node 160. The execution of the smart contract (e.g., signed by both of the SB node 120 and the SB node 160) may trigger the processing of the funds transfer transaction.

At step 1025, the SB node 120 may execute a first set of postings associated with the funds transfer on the blockchain 102. The first set of postings may include postings associated with changes to different accounts involved in the funds transfer transaction in the first ledger of the blockchain 102. In some embodiments, the first set of postings may include a first posting associated with processing a debit of the funds from the first account associated with the PB node 130, a second posting associated with processing a credit of the funds to a first intermediate account associated with the SB node 120, a third posting associated with processing a debit of the funds from the first intermediate account associated with the SB node 120, and a fourth posting associated with processing a credit of the funds to the second intermediate account associated with the SB node 160.

The SB node 120 then causes (at step 1030) the PB node 130 associated with the first account to execute a subset of the set of postings, such as the first posting associated with processing a debit of the funds from the first account associated with the PB node 130. The SB node 120 also causes (at step 1035) the SB node 160 associated with the second settlement entity to execute a second set of postings. The second set of postings may include postings associated with changes to different accounts involved in the funds transfer transaction in the second ledger of the blockchain 102. In some embodiments, the second set of postings may include a first posting associated with processing a debit of the funds from the second intermediate account associated with the SB node 160, and a second posting associated with processing a credit of the funds to the second account associated with the PB node 170. In some embodiments, the SB node 160 also causes the PB node 170 to process a subset of the second set of postings, such as the second posting associated with processing a credit of the funds to the second account associated with the PB node 170.

In some embodiments, the SB node 120, the SB node 160, the PB node 130, and the PB node 170 may collaborate in executing a single atomic transaction that updates the first ledger and the second ledger on the blockchain 102 based on the funds transfer transaction. After completing the funds transfer transaction, the SB node 120 may transmit (at step 1040) a transaction complete message to the other computer nodes involved in the transaction, such as the SB node 160, the PB node 130, and the PB node 170.

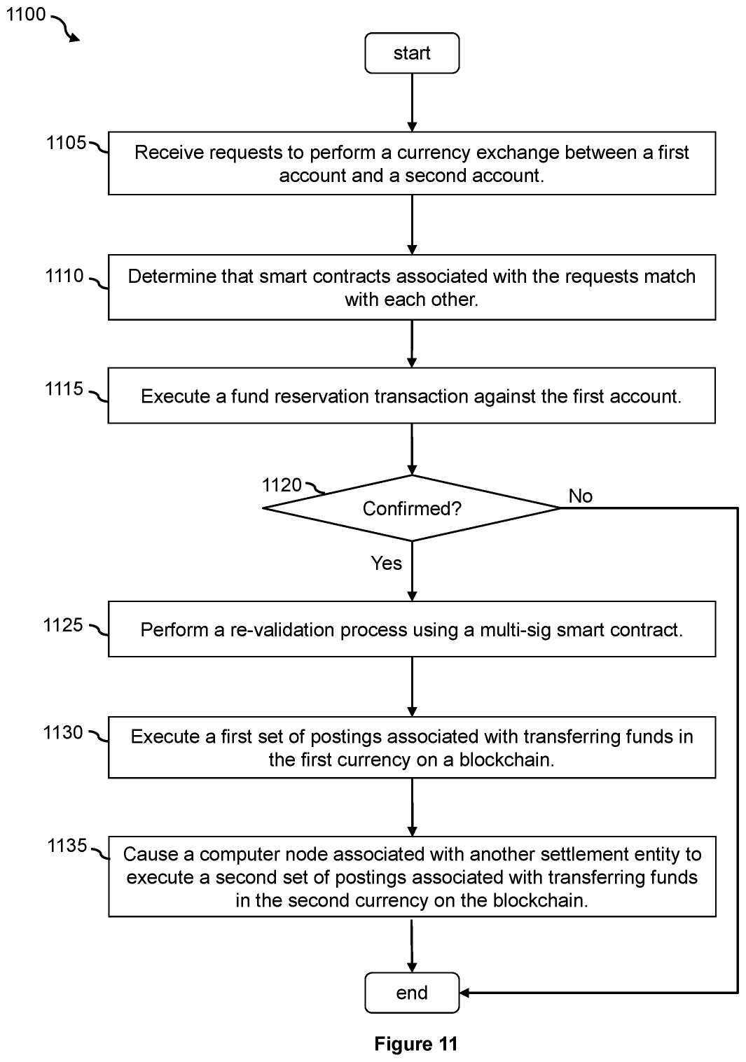

FIG. 11 illustrates a process 1100 for performing a foreign exchange transfer transaction on a blockchain according to various embodiments of the disclosure. In some embodiments, at least a portion of the process 1100 may be performed by the transaction module of one or more computer nodes within a blockchain network. The process 1100 is related to a foreign exchange where a first participating entity exchanges funds in a first currency with funds in a second currency from a second participating entity. Both of the first participating entity and the second participating entity may have nostro relationships with a first settlement entity configured to managed accounts in the first currency in a first ledger, and nostro relationships with a second settlement entity configured to manage accounts in the second currency in a second ledger.

The process 1100 begins by receiving (at step 1105) a request to perform a foreign exchange transaction (e.g., a currency exchange) between a first account and a second account. For example, the PB1 node 812 and the PB2 node 824 may transmit a foreign exchange request to the SB1 node 810 and the SB2 node 820. Each request received by the SB1 node 810 and the SB2 node 820 may include a smart contract that represents an exchange of funds in a first currency from the first participating entity with funds in a second currency from the second participating entity. Upon receiving the request, the SB1 node 810 and/or the SB2 node 820 determines (at step 1110) that the smart contracts associated with the requests match with each other. For example, the SB1 node 810 and/or the SB2 node 820 may determine if the amounts specified in both smart contracts correspond to each other, if the entities involved in the exchange and specified in the smart contracts match, etc.

When the smart contracts are matched, the SB1 node 810 executes (at step 1115) a funds reservation transaction against the first account. For example, the SB1 node 810 may initiate a funds reservation transaction on the blockchain 102, where funds of the particular amount in the first currency specified in the request is reserved on the first ledger of the blockchain 102 for a duration (e.g., a number of blocks on the blockchain 102). Upon a successful execution of the funds reservation transaction, the SB1 node 810 may receive a funds reservation confirmation.

In some embodiments, the SB2 node 820 also executes another funds reservation transaction against the second account of the second participating entity, such that the funds in the second currency specified in the request is reserved on the second ledger of the blockchain 102 for the duration. Upon a successful execution of the funds reservation transaction, the SB2 node 820 may receive a funds reservation confirmation.

At step 1120, the SB1 node 120 determines whether the funds reservation confirmation is received. If the funds reservation confirmation is not received, the process 1000 ends. However, if the funds reservation confirmation is received, the SB node 120 may collaborate with computer nodes involved in the foreign exchange transaction to process the foreign exchange transaction on the blockchain 102. Since the processing of the foreign exchange transaction in this example requires updates to two different ledgers managed by different settlement entities (e.g., the first ledger managed by the SB1 node 810 and the second ledger managed by the SB2 node 820), the updates to the two ledgers need to be processed together (or fail together). As such, the SB1 node 810 and/or the SB2 node 820 may perform (at step 1125) a re-validation process using a multi-signature smart contract. For example, the SB1 node 810 and/or the SB2 node 820 may generate and execute a multi-signature smart contract that requires digital signatures from both of the SB1 node 810 and the SB2 node 820. The execution of the smart contract (e.g., signed by both of the SB1 node 810 and the SB2 node 820) may trigger the processing of the foreign exchange transaction.

At step 1130, the SB1 node 810 executes a first set of postings associated with the foreign exchange on the blockchain 102. The first set of postings may include postings associated with changes to different accounts involved in the foreign exchange transaction in the first ledger of the blockchain 102. In some embodiments, the first set of postings may include a first posting associated with processing a debit of the funds in the first currency from a first currency account associated with the PB1 node 812, a second posting associated with processing a credit of the funds in the first currency to a first intermediate account associated with the SB1 node 810, a third posting associated with processing a debit of the funds in the first currency from the first intermediate account associated with the SB1 node 810, and a fourth posting associated with processing a credit of the funds in the first currency to a first currency account associated with the PB2 node 824.

The SB1 node 810 then causes (at step 1135) the SB2 node 820 associated with the second settlement entity to execute a second set of postings. The second set of postings may include postings associated with changes to different accounts involved in the foreign exchange transaction in the second ledger of the blockchain 102. In some embodiments, the second set of postings may include a first posting associated with processing a debit of the funds in the second currency from a second currency account associated with the PB2 node 824, a second posting associated with processing a credit of the funds in the second currency to a second intermediate account associated with the SB2 node 824, a third posting associated with processing a debit of the funds in the second currency from the second intermediate account associated with the SB2 node 824, and a fourth posting associated with processing a credit of the funds in the second currency to a second currency account associated with the PB1 node 812.

In some embodiments, the SB1 node 810, the SB2 node 820, the PB1 node 812, and the PB2 node 824 may collaborate in executing a single atomic transaction that updates the first ledger and the second ledger on the blockchain 102 based on the foreign exchange transaction. After completing the foreign exchange transaction, the SB1 node 810 may transmit a transaction complete message to the other computer nodes involved in the transaction, such as the SB2 node 820, the PB1 node 812, and the PB2 node 824.

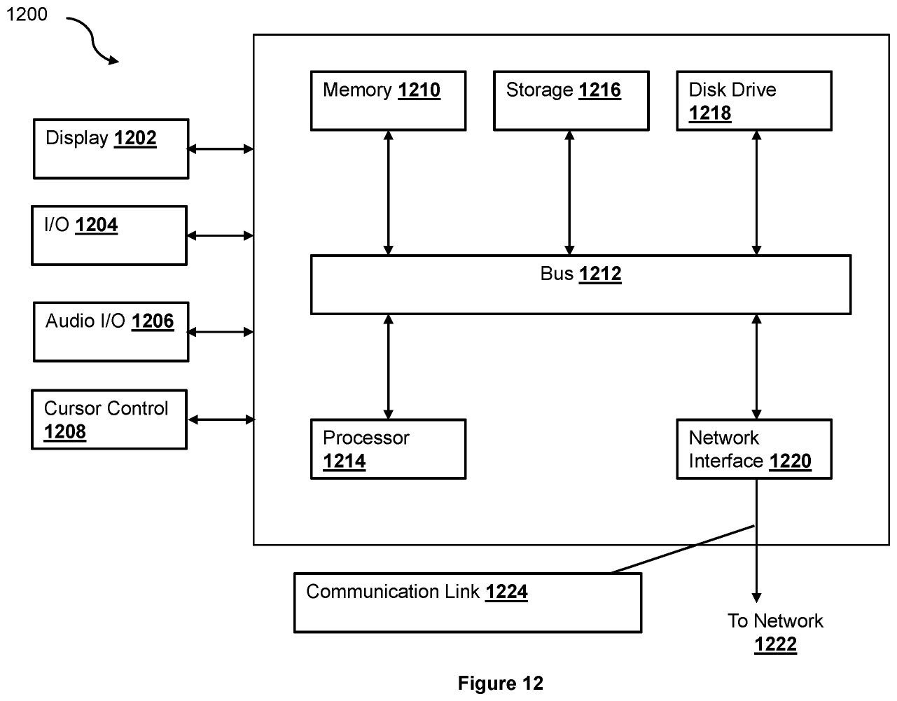

FIG. 12 is a block diagram of a computer system 1200 suitable for implementing one or more embodiments of the present disclosure, including the SB node 120, the SB node 160, the PB node 130, the PB node 140, the PB node 170, the PB node 180, the SB1 node 410, the PB1 node 412, the PB2 node 414, the SB1 node 710, the SB2 node 720, the PB1 node 712, the PB2 node 724, the SB1 node 810, the SB2 node 820, the PB1 node 812, and the PB2 node 824. In various implementations, each of the SB node 120, the SB node 160, the PB node 130, the PB node 140, the PB node 170, the PB node 180, the SB1 node 410, the PB1 node 412, the PB2 node 414, the SB1 node 710, the SB2 node 720, the PB1 node 712, the PB2 node 724, the SB1 node 810, the SB2 node 820, the PB1 node 812, and the PB2 node 824 may include a network computing device, such as a server. Thus, it should be appreciated that the SB node 120, the SB node 160, the PB node 130, the PB node 140, the PB node 170, the PB node 180, the SB1 node 410, the PB1 node 412, the PB2 node 414, the SB1 node 710, the SB2 node 720, the PB1 node 712, the PB2 node 724, the SB1 node 810, the SB2 node 820, the PB1 node 812, and the PB2 node 824 may be implemented as the computer system 1200 in a manner as follows.

The computer system 1200 includes a bus 1212 or other communication mechanism for communicating information data, signals, and information between various components of the computer system 1200. The components include an input/output (I/O) component 1204 that processes a user (i.e., sender, recipient, service provider) action, such as selecting keys from a keypad/keyboard, selecting one or more buttons or links, etc., and sends a corresponding signal to the bus 1212. The I/O component 1204 may also include an output component, such as a display 1202 and a cursor control 1208 (such as a keyboard, keypad, mouse, etc.). The display 1202 may be configured to present a login page for logging into a user account or a checkout page for purchasing an item from a merchant. An optional audio input/output component 1206 may also be included to allow a user to use voice for inputting information by converting audio signals. The audio I/O component 1206 may allow the user to hear audio. A transceiver or network interface 1220 transmits and receives signals between the computer system 1200 and other devices, such as another user device, a merchant server, or a service provider server via a network 1222. In one embodiment, the transmission is wireless, although other transmission mediums and methods may also be suitable. A processor 1214, which can be a micro-controller, digital signal processor (DSP), or other processing component, processes these various signals, such as for display on the computer system 1200 or transmission to other devices via a communication link 1224. The processor 1214 may also control transmission of information, such as cookies or IP addresses, to other devices.

The components of the computer system 1200 also include a system memory component 1210 (e.g., RAM), a static storage component 1216 (e.g., ROM), and/or a disk drive 1218 (e.g., a solid-state drive, a hard drive). The computer system 1200 performs specific operations by the processor 1214 and other components by executing one or more sequences of instructions contained in the system memory component 1210. For example, the processor 1214 can perform the blockchain-based inter-bank transaction processing functionalities described herein.

Logic may be encoded in a computer readable medium, which may refer to any medium that participates in providing instructions to the processor 1214 for execution. Such a medium may take many forms, including but not limited to, non-volatile media, volatile media, and transmission media. In various implementations, non-volatile media includes optical or magnetic disks, volatile media includes dynamic memory, such as the system memory component 1210, and transmission media includes coaxial cables, copper wire, and fiber optics, including wires that comprise the bus 1212. In one embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by the computer system 1200. In various other embodiments of the present disclosure, a plurality of computer systems 1200 coupled by the communication link 1024 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A system comprising:
a non-transitory memory; and
one or more hardware processors coupled with the non-transitory memory and configured to execute instructions from the non-transitory memory to cause the system to perform operations comprising:
receiving, from a device, a fund transfer request for transferring funds from a first account associated with a first computer node to a second account associated with a second computer node;
executing, based on the fund transfer request, a funds reservation transaction for reserving the funds in association with the first account on a blockchain; and
in response to receiving a confirmation of the funds reservation transaction, triggering an execution of an atomic transaction on the blockchain, wherein the triggering the execution of the atomic transaction comprises processing a set of postings associated with the fund transfer request on the blockchain and causing each of the first computer node and the second computer node to process a different portion of the set of postings.

2. The system of claim 1, wherein the funds reservation transaction specifies an expiration time.

3. The system of claim 1, wherein the set of postings comprises a first posting associated with debiting the funds from the first account, a second posting associated with crediting the funds to a third account associated with the system, a third posting associated with debiting the funds from the third account, and a fourth posting associated with crediting the funds to the second account.

4. The system of claim 3, wherein the triggering the execution of the atomic transaction comprises causing the first computer node to process the first posting, but not the second, third, and fourth postings, in the set of postings.

5. The system of claim 3, wherein the triggering the execution of the atomic transaction comprises causing the second computer node to process the fourth posting, but not the first, second, and third postings, in the set of postings.

6. The system of claim 1, wherein the set of postings is processed as a single transaction on the blockchain.

7. The system of claim 1, wherein the operations further comprise:
in response to receiving the confirmation of the funds reservation transaction, transmitting a funds reservation confirmation message to the first computer node and the second computer node.

8. A method comprising:
receiving, by a computer system associated with a first intermediary entity, a fund transfer request for transferring funds from a first account associated with a first entity to a second account associated with a second entity;
executing, by the computer system based on the fund transfer request, a funds reservation transaction for reserving the funds in association with the first account on a blockchain; and
in response to receiving a confirmation of a funds reservation event, triggering, by the computer system, an execution of an atomic transaction on the blockchain, wherein the triggering the execution of the atomic transaction comprises processing a set of postings associated with the fund transfer request on the blockchain and causing a first computer node associated with the first entity to process a portion of the set of postings.

9. The method of claim 8, wherein the atomic transaction is processed using a multi-signature smart contract.

10. The method of claim 8, wherein the set of postings comprises a first posting associated with debiting the funds from the first account, a second posting associated with crediting the funds to a third account associated with the computer system, a third posting associated with debiting the funds from the third account, and a fourth posting associated with crediting the funds to a fourth account associated with a second intermediary entity.

11. The method of claim 8, wherein the blockchain stores transactions associated with at least a first ledger and a second ledger, and wherein the set of postings is associated with the first ledger.

12. The method of claim 11, wherein the set of postings is a first set of postings, and wherein the triggering the execution of the atomic transaction further comprises causing a second computer node associated with a second intermediary entity to process a second set of postings associated with the second ledger.

13. The method of claim 12, wherein the first entity has a nostro relationship with the first intermediary entity, but not with the second intermediary entity, and wherein the second entity has a nostro relationship with the second intermediary entity, but not with the first intermediary entity.

14. The method of claim 11, wherein the first ledger is associated with a first currency, and wherein the second ledger is associated with a second currency different from the first currency.

15. A non-transitory machine-readable medium having stored thereon machine-readable instructions executable to cause a machine associated with an intermediary entity to perform operations comprising:
receiving a fund transfer request for transferring funds from a first account associated with a first participating entity to a second account associated with a second participating entity;
executing, based on the fund transfer request, a funds reservation transaction for reserving the funds in association with the first account on a blockchain; and
in response to receiving a confirmation of a funds reservation event, triggering an execution of an atomic transaction on the blockchain, wherein the triggering the execution of the atomic transaction comprises processing a set of postings associated with the fund transfer request on the blockchain and causing a first computer node associated with the first participating entity to process a portion of the set of postings.

16. The non-transitory machine-readable medium of claim 15, wherein the set of postings comprises a first posting associated with debiting the funds from the first account, a second posting associated with crediting the funds to a third account associated with the intermediary entity, a third posting associated with debiting the funds from the third account, and a fourth posting associated with crediting the funds to the second account.

17. The non-transitory machine-readable medium of claim 16, wherein the triggering the execution of the atomic transaction comprises causing the first computer node to process the first posting, but not the second, third, and fourth postings, in the set of postings.

18. The non-transitory machine-readable medium of claim 17, wherein the triggering the execution of the atomic transaction comprises causing the second computer node to process the fourth posting, but not the first, second, and third, in the set of postings.

19. The non-transitory machine-readable medium of claim 15, wherein the set of postings is processed as a single transaction on the blockchain.

20. The non-transitory machine-readable medium of claim 15, wherein the operations further comprise:
in response to receiving the confirmation of the funds reservation transaction, transmitting a funds reservation confirmation message to the first computer node and the second computer node.
